(19) United States
(12) Patent Application Publication
(10) Pub. No.: US 2024/0202493 A1
(43) Pub. Date: Jun. 20, 2024

(54) METHOD AND SERVER FOR SEARCHING FOR OPTIMAL NEURAL NETWORK ARCHITECTURE BASED ON CHANNEL CONCATENATION

(71) Applicant: ELECTRONICS AND TELECOMMUNICATIONS RESEARCH INSTITUTE, Daejeon (KR)

(72) Inventors: Hyunwoo CHO, Daejeon (KR); Iksoo SHIN, Daejeon (KR); Chang Sik CHO, Daejeon (KR)

(73) Assignee: ELECTRONICS AND TELECOMMUNICATIONS RESEARCH INSTITUTE, Daejeon (KR)

(21) Appl. No.: 18/510,199

(22) Filed: Nov. 15, 2023

(30) Foreign Application Priority Data
Dec. 20, 2022 (KR) 10-2022-0179159

(51) Int. Cl. G06N 3/04

(52) U.S. Cl. CPC G06N 3/04

(57) ABSTRACT

Provided is a method of searching for optimal neural network architecture based on channel concatenation. The method includes adjusting spatial size information of an input feature map candidate group so that the spatial size information of the input feature map candidate group corresponds to spatial size information of an output feature map, performing a channel-based concatenation operation on the input feature map candidate group, and additionally extending an output feature map that is the results of the channel-concatenated operation to the input feature map candidate group.

### CROSS-REFERENCE TO RELATED APPLICATION

This application claims priority to and the benefit of Korean Patent Application No. 10-2022-0179159, filed on Dec. 20, 2022, the disclosure of which is incorporated herein by reference in its entirety.

### BACKGROUND

### 1. Technical Field

The present disclosure relates to a method and server for searching for optimal neural network architecture based on channel concatenation.

### 2. Related Art

Recently, in the deep learning field, many artificial intelligence researchers have continuously developed neural network architecture and a computation operation block in order to enable more accurate and faster inference depending on the use of a neural network, a data set that is used in learning, and an operating device to be actually inferred.

Furthermore, attempts to automatically find more suitable neural network architecture like neural architecture search are made with respect to a (NAS) specific scenario.

However, in the case of conventional NAS, a technology for a structure after a backbone needs to be developed because only research of the structure of the backbone is carried out in most cases.

### SUMMARY

Various embodiments are directed to providing a method and server for searching for optimal neural network architecture based on channel concatenation, which can search for optimal architecture for neural network architecture that is constructed based on concatenation not the sum.

However, objects of the present disclosure to be achieved are not limited to the aforementioned object, and other objects may be present.

A method of searching for optimal neural network architecture based on channel concatenation according to a first aspect of the present disclosure may include adjusting spatial size information of an input feature map candidate group so that the spatial size information of the input feature map candidate group corresponds to spatial size information of an output feature map, performing a channel-based concatenation operation on the input feature map candidate group, and additionally extending an output feature map that is the results of the channel-concatenated operation to the input feature map candidate group.

Furthermore, a method of searching for optimal neural network architecture based on channel concatenation according to a second aspect of the present disclosure may include setting spatial size information of an output feature map, adjusting spatial size information of an input feature map candidate group so that the spatial size information of the input feature map candidate group corresponds to spatial size information of an output feature map, performing a channel-based concatenation operation on the input feature map candidate group, additionally extending an output feature map that is the results of the channel-concatenated operation to the input feature map candidate group, and performing learning for searching for a one-shot neural network on a super-net including each node corresponding to the additionally extended input feature map candidate group.

Furthermore, a server for searching for optimal neural network architecture based on channel concatenation according to a third aspect of the present disclosure may include memory in which a program for searching for optimal neural network architecture based on channel concatenation is stored, and a processor configured to set spatial size information of an output feature map, adjust spatial size information of an input feature map candidate group so that the spatial size information of the input feature map candidate group corresponds to spatial size information of map, perform an output feature a channel-based concatenation operation on the input feature map candidate group, additionally extend an output feature map that is the results of the channel-concatenated operation to the input feature map candidate group, and perform learning for searching for a one-shot neural network on a super-net including each node corresponding to the additionally extended input feature map candidate group, when executing the program stored in the memory.

A computer program according to another aspect of the present disclosure executes the method of searching for optimal neural network architecture based on channel concatenation in combination with a computer, that is, hardware, and is stored in a computer-readable recording medium.

Other details of the present disclosure are included in the detailed description and the drawings.

According to the embodiments of the present disclosure, optimal neural network architecture can be effectively searched for with respect to a channel concatenation-based neck structure of an object detection neural network. Accordingly, there is an advantage in that a more precise neural network can be generated compared to a case in which predetermined architecture was simply applied to the neck in the existing NAS based on the backbone.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a diagram for describing element-wise sum-based NAS.

FIG. 2 is a flowchart of a method of searching for optimal neural network architecture based on channel concatenation according to an embodiment of the present disclosure.

FIG. 3 is a diagram for describing NAS based on channel concatenation in an embodiment of the present disclosure.

FIG. 4 is a diagram for describing a construction of a concatenation node in an embodiment of the present disclosure.

FIG. 5 is a diagram for describing a convolution neural network.

FIG. 6 is a diagram of an example of up-sampling and a channel reduction.

FIG. 7 is a diagram for describing a sampling structure in an embodiment of the present disclosure.

FIG. 8 is a diagram for describing a feature merge cell structure for searching for optimal neural network architecture according to an embodiment of the present disclosure.

FIG. 9 is a diagram of an example of a node selection sequence according to a PAN structure in an embodiment of the present disclosure.

FIGS. 10A to 10F are diagrams for describing contents in which a candidate input feature map in the PAN structure is set in an embodiment of the present disclosure.

FIG. 11 is a diagram for describing a process of adjusting spatial size information of an input feature map candidate group in an embodiment of the present disclosure.

FIG. 12 is a diagram for describing contents in which a structure parameter is applied to an input feature map candidate group in an embodiment of the present disclosure.

FIG. 13 is a block diagram of a server for searching for optimal neural network architecture based on channel concatenation according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element.

Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Hereinafter, in order to help understanding of those skilled in the art, a proposed background of the present disclosure is first described and an embodiment of the present disclosure is then described.

Most of neural architecture search (NAS) research is research of the structure of a backbone (i.e., a feature extraction neural network). In the vision field, basically, the structure of the backbone may be directly applied to image classification. However, in an object detection neural network, the backbone is important, but to well fuse features extracted from the backbone after the backbone is also very important. This is because unlike in image classification, in order to detect an object, the location of the object needs to be able to be predicted without being limited to simply identifying the object.

Currently, most of object detection neural networks having good performance may be divided into a feature extraction neural network (backbone), a feature merge neural network (neck), and a result prediction neural network (head). In this case, the feature merge neural network (hereinafter referred to as a “neck”) needs to fuse feature maps that are extracted from the feature extraction neural network (hereinafter referred to as a “backbone”) and that have several types of resolution and to transmit the fused feature map to the result prediction neural network (hereinafter referred to as a “head”). This has a great influence on the accuracy of location prediction, in particular.

On the back of many researchers' contribution to the neck structure of the object detection neural network, the neck structure is being developed into a feature pyramid network (FPN) in which a feature map having low resolution is concatenated into a feature map having high resolution, a path aggregation network (PAN) in which a feature map having high resolution is concatenated into a feature map having low resolution with respect to the output feature map of the FPN, and a BiFPN in which some paths are omitted and a feature map having the same resolution from the backbone is concatenated into the PAN, from an initial method of simply transmitting feature maps having several types of resolution to each head.

Basically, such a neck structure may play a role to maintain information on other resolution by concatenating different inputs in the direction of a channel without summing the inputs in an element-wise manner. However, research of a NAS algorithm to automatically find optimal architecture with respect to a neural network based on channel concatenation is not present.

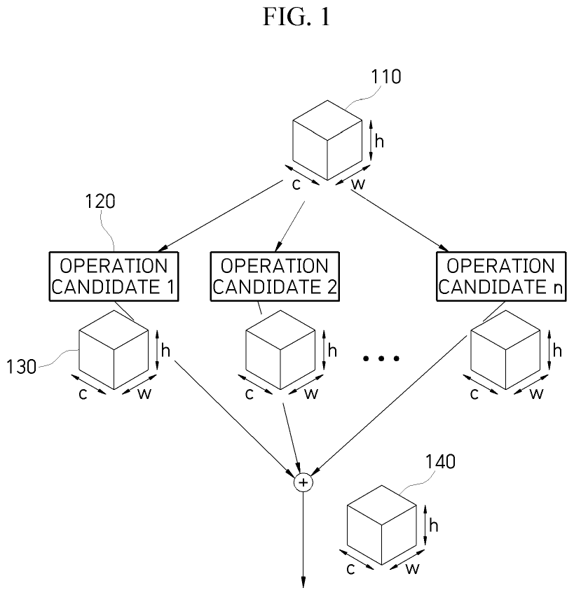

FIG. 1 is a diagram for describing element-wise sum-based NAS. In this case, a structure illustrated in FIG. 1 has an object of selecting any one of a plurality of operation candidates between the input and output of a specific node.

In the existing sum-based one-shot NAS, it is assumed that several operation candidates 120 are present and an input tensor 110 generates an output 130 having the same tensor size (channel×height×width) although the input tensor performs an operation of any candidate. The reason for this is that if the input tensor does not generate the output having the same tensor size, an element-wise sum between tensors is impossible. Furthermore, even after an operation of summing inputs to several operation candidates, an output having the same tensor size is generated (140).

In this case, the element-wise sum may be a weighted sum of summing inputs to the operation candidates by applying a weight to each operation candidate in addition to a simple sum.

However, in the neck of the object detection neural network, unlike in the backbone, a connection structure between different types of resolution is very important. Furthermore, in order to soundly preserve location information, it is necessary to merge feature maps having different types of resolution through channel concatenation without summing the feature maps. However, NAS in the existing backbone is inappropriate for searching for an optimal neck structure because the NAS has been developed as an algorithm for a sum-based structure with respect to an input candidate group.

Accordingly, an embodiment of the present disclosure proposes a new algorithm capable of automatically searching for optimal architecture with respect to neural network architecture that is constructed based on channel concatenation like a neck structure of an object detection neural network.

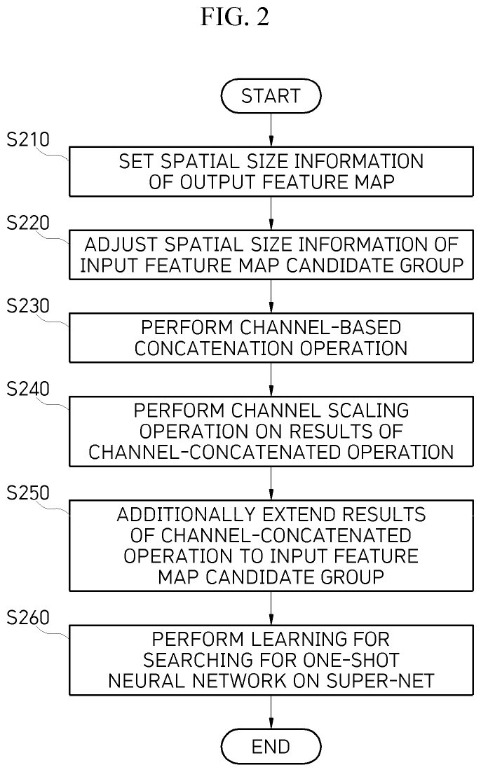

Hereinafter, a method of searching for optimal neural network architecture based on channel concatenation according to an embodiment of the present disclosure is described with reference to FIGS. 2 to 12.

FIG. 2 is a flowchart of a method of searching for optimal neural network architecture based on channel concatenation (hereinafter referred to as an “optimal neural network architecture search method”) according to an embodiment of the present disclosure.

The optimal neural network architecture search method according to an embodiment of the present disclosure is performed by including a step S210 of setting spatial size information of an output feature map, a step S220 of adjusting spatial size information of an input feature map candidate group so that the spatial size information of the input feature map candidate group corresponds to the spatial size information of the output feature map, a step S230 of performing a channel-based concatenation operation on the input feature map candidate groups, a step S240 of performing a channel scaling operation on an output feature map, that is, the results s of the channel-concatenated operation, a step S250 of additionally extending the output feature map, that is, the results of the channel-concatenated operation, to the input feature map candidate group, and a step S260 of performing learning for searching for a one-shot neural network on a super-net including each node corresponding to the additionally extended input feature map candidate group.

Each of the steps illustrated in FIG. 2 may be understood as being performed by a server for searching for optimal neural network architecture based on channel concatenation, which is described later, but the present disclosure is not essentially limited thereto.

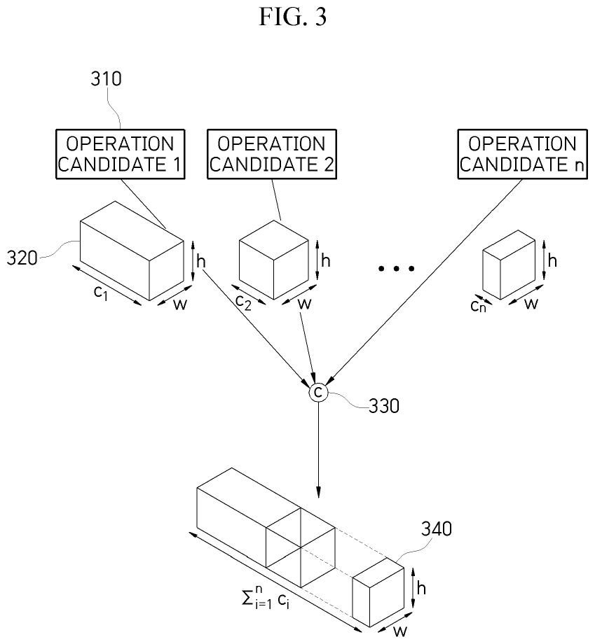

FIG. 3 is a diagram for describing NAS based on channel concatenation in an embodiment of the present disclosure. In this case, a structure illustrated in FIG. 3 has an object of determining which nodes, among previous nodes, will be connected to the input of a channel concatenation node.

In one-shot NAS based on channel concatenation in an embodiment of the present disclosure, output values 320 of several operation candidates 310 may not essentially have the same tensor shape. That is, the output results have only to have the same spatial size information (height (h)×width (w)).

In this case, the output values 320 of the operation candidates 310 are not the sum, but need to be concatenated in the direction of a channel (330). Accordingly, after an operation of concatenating the inputs (candidate input feature maps) to several operation candidates, the output values are output to have the size of a tensor having an increased channel length (340). Accordingly, if the concatenation operation is continuously performed, the channel direction may be indefinitely increased toward the back of the channel.

All of the candidate input feature maps in FIG. 3 are in the state in which down-sampling or up-sampling has already been completed based on spatial size information (h×w) of an output tensor (or an output feature map).

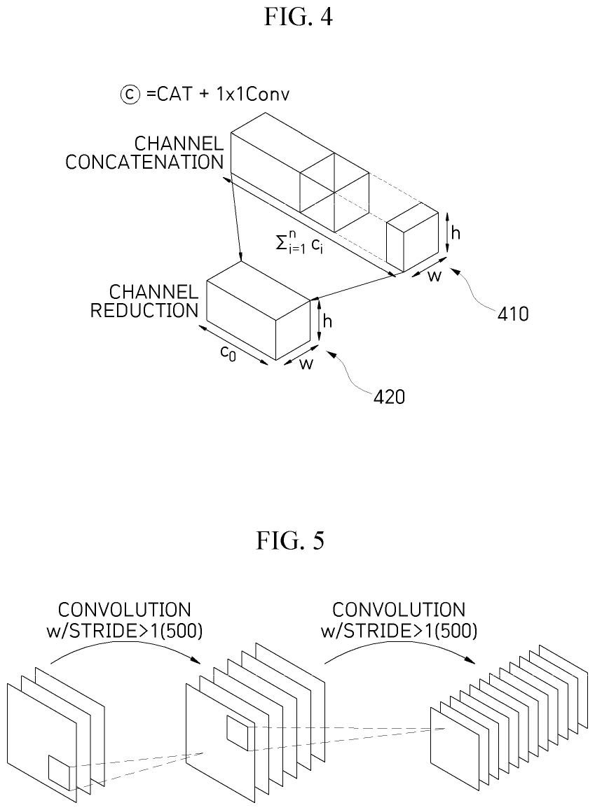

FIG. 4 is a diagram for describing a construction of a concatenation node in an embodiment of the present disclosure.

In an embodiment of the present disclosure, in order to overcome the problem in that the channel direction is indefinitely increased, a channel scaling operation is performed on an output feature map 410, that is, the results of a channel-concatenated operation (S240).

As an embodiment, as the simplest channel scaling method, the spatial size information (h×w) is maintained, but only the length of the output channel may be changed by using a convolution product having a kernel size 1×1 and a kernel stride 1 (420).

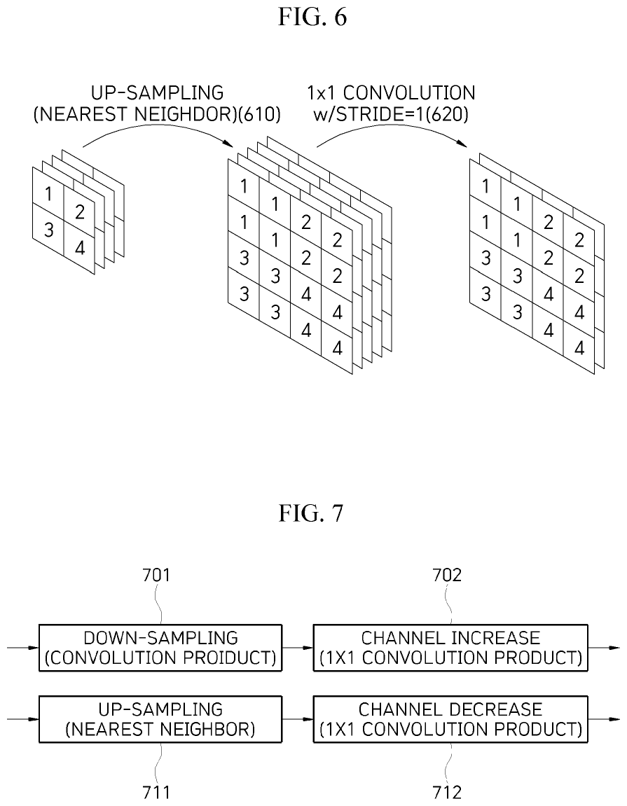

FIG. 5 is a diagram for describing a convolution neural network (CNN). FIG. 6 is a diagram of an example of up-sampling and a channel reduction.

In the case of the existing successful CNN, it may be seen that when the spatial size information (h×w) of the output tensor is changed, the channel is also scaled in response to the change. For example, if a convolution product operation is performed, when the height and width are reduced by half, the output channel of the convolution product operation may be set to be doubled (500).

In contrast, if the spatial size information (h×w) of the output tensor is doubled through an up-sampling operation (610), a separate operation for reducing the output channel is used (620).

For reference, after the convolution product operation, the spatial size information (h×w) of the output tensor is different depending on a stride in which a convolution product kernel moves. For example, a tensor having the same size as an input tensor is output when the stride is 1, and a tensor having a smaller size than the input tensor is output when the stride is 2 or more. Furthermore, after the convolution product operation, a channel length of the output tensor is identical with the number of convolution product kernels.

FIG. 7 is a diagram for describing a sampling structure in an embodiment of the present disclosure.

In an embodiment of the present disclosure, a structure for performing down-sampling and up-sampling has been consistently constructed as in FIG. 7. That is, the structure is constructed to include a down-sampling (or up-sampling) operation and a channel scaling operation.

In this case, the down-sampling (or up-sampling) operation outputs a tensor having the same length as the channel of an input tensor (701, 702). Furthermore, the channel scaling operation outputs a tensor having the same spatial size information as the same spatial size information of the input tensor (711, 712).

In this case, as described with reference to FIG. 5, upon down-sampling, the channel may be increased by only the convolution product operation. However, in an embodiment of the present disclosure, in order to make a structure for up-sampling and a structure for down-sampling symmetrical to each other, a separate 1×1 convolution product is added without changing the channel in a convolution product in down-sampling.

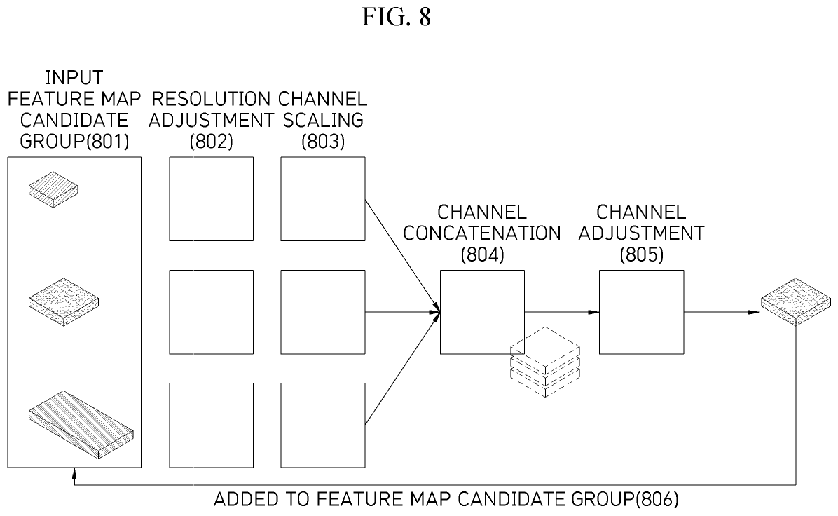

FIG. 8 is a diagram for describing a feature merge cell structure for searching for optimal neural network architecture according to an embodiment of the present disclosure.

In the neck structure of an object detection neural network, in general, feature maps having different types of spatial size information are produced as a feature map having one type of spatial size information through concatenation. FIG. 8 illustrates such a process, and is a basic cell structure for searching for optimal neural network architecture based on channel concatenation, which is proposed in the present disclosure.

First, spatial size information of an output feature map is set (S210, set output resolution).

Next, spatial size information of an input feature map candidate group 801 is adjusted so that the spatial size information of the input feature map candidate group corresponds to the spatial size information of the output feature map (S220, adjust input resolution). In this case, step S220 is to adjust the spatial size information through resolution adjustment 802 and channel scaling 803, and may be performed in plural times according to circumstances.

As an embodiment, in step S220, when spatial size information of an input feature map included in the input feature map candidate group is greater than the spatial size information of the output feature map, the spatial size is decreased by using a convolution product operation having a stride size of 2 or more or an operation set including a corresponding convolution product. Thereafter, the length of the channel may be increased by applying a 1×1 convolution product operation so that the spatial size information of the input feature map is adjusted to be identical with the spatial size information of the output feature map.

In contrast, when the spatial size information of the input feature map included in the input feature map candidate group is smaller than the spatial size information of the output feature map, the spatial size is increased by using an up-sampling operation. Thereafter, the length of the channel may be reduced by applying a 1×1 convolution product operation so that the spatial size information of the input feature map is adjusted to be identical with the spatial size information of the output feature map.

Next, a channel-based concatenation operation 804 is performed on the input feature map candidate group (S230, input concatenation). In step S230, all of the input feature map candidate groups are inputs to a concatenation operation. In this case, the inputs are concatenated in the length of the channel because the inputs have the same spatial size.

Next, a channel scaling operation 805 is performed on a feature map, that is, the results of the channel-concatenated operation. In such a process, the length of the channel is reduced by using a 1×1 convolution product (S240, reduce the output channel).

Next, an output feature map, that is, the results of the channel-concatenated operation, is added and extended to the input feature map candidate group (806) (S250, extend the input feature map candidate group).

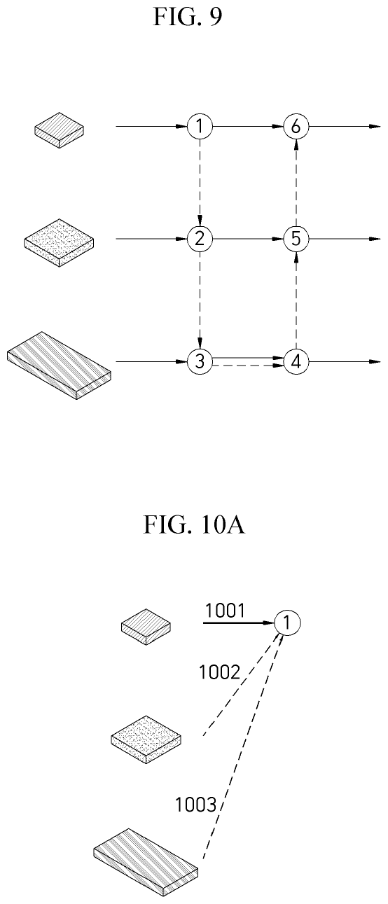

FIG. 9 is a diagram of an example of a node selection sequence according to a PAN structure in an embodiment of the present disclosure.

In an embodiment of the present disclosure, in performing step S210 of setting the s spatial size information of the output feature map, the spatial size information of the output feature map may be set by putting the following restrictions without fully setting the spatial size information corresponding to an arbitrary node after selecting the arbitrary node.

First, resolution of an output feature map is not arbitrarily set, but may be set to corresponding to spatial size information of an output feature map in a corresponding node that follows a PAN path sequence. For example, a node (cell) that is indicated by a number in FIG. 9 may be sequentially selected. In this case, the node in which the number is indicated in FIG. 9 means a node including channel concatenation. The number means a sequence in which a corresponding node is selected.

Furthermore, it is assumed that although a feature merge portion (neck) is not present, a path that is essentially required is always selected as an input to a corresponding node. Accordingly, an arrow indicated by a solid line in FIG. 9 is an essential input feature map. In this case, the essential input feature map for each concatenation node is a feature map having the same spatial size information, and is output from a node that has been generated most recently.

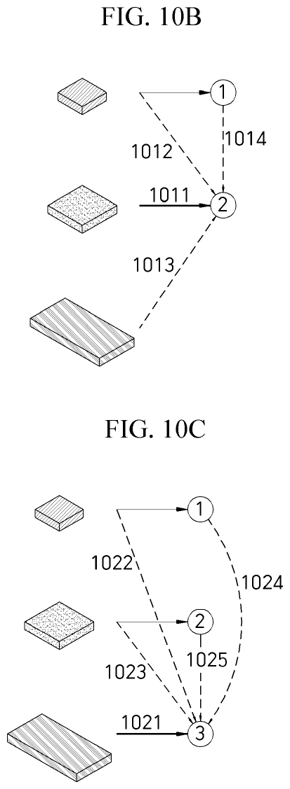

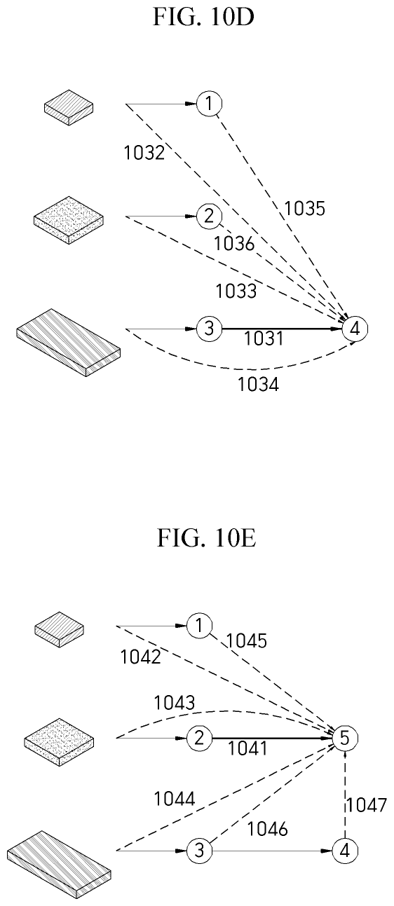

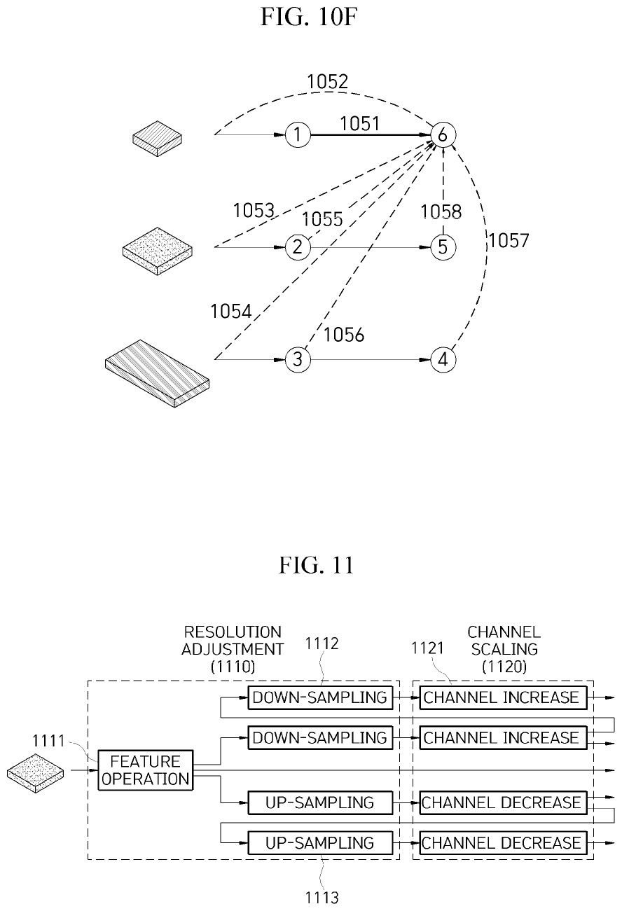

Furthermore, a candidate input feature map (i.e., a dotted line in FIG. 10) other than the essential input feature map is input after being multiplied by a structure parameter. In this case, the structure parameter has a real number value to which a softmax function has been applied. The real number value is a differentiable value which allows the structure parameter to have a value between 0 and 1 while having a kind of probability value property so that the sum of all of the values becomes 1.

FIGS. 10A to 10F are diagrams for describing contents in which a candidate input feature map in a PAN structure is set in an embodiment of the present disclosure.

As an embodiment, in the present disclosure, an input feature map to be included in an input feature map candidate group is determined based on spatial size information of an output feature map.

Specifically, if a first node according to a PAN path sequence is a node connected to a backbone, an input feature map having the same resolution from the backbone is set as an essential input feature map. Furthermore, an input feature map having different resolution from the backbone is set as a candidate input feature map. In this case, if an output feature map from another node is present, the output feature map of the another node may also be set as a candidate input feature map.

In relation to such setting, referring to FIGS. 10A to 10C, an essential input feature map of a No. 1 node is an input having the same resolution from the backbone (1001). Furthermore, the remaining candidate input feature map which may be selected includes a total of two (1002 and 1003), including inputs having middle resolution and high resolution from the backbone (FIG. 10A).

An essential input feature map of a No. 2 node is an input having the same resolution from the backbone (1011). Furthermore, the remaining candidate input feature maps which may be selected include a total of three, including inputs 1012 and 1013 having high resolution and low resolution from the backbone and a tensor 1014 that is output from the No. 1 node (FIG. 10B).

An essential input feature map of a No. 3 node is an input having the same resolution from the backbone (1021). Furthermore, the remaining candidate input feature map which may be selected includes a total of four, including inputs 1022 and 1023 having middle resolution and low resolution from the backbone and tensors 1024 and 1025 that are output from the Nos. 1 and 2 nodes (FIG. 10C).

Furthermore, if a second node according to the PAN path sequence is a node connected to the first node not the backbone, an input feature map having the same resolution from the first node is set as an essential input feature map. Furthermore, an input feature map from the backbone is set as a candidate input feature map. In this case, if an output feature map from another node is present, the output feature map of the another node may also be set as a candidate input feature map.

In relation to such setting, referring to FIGS. 10D to 10F, an essential input feature map of a No. 4 node is an input having the same resolution from the No. 3 node (1031). Furthermore, the remaining candidate input feature map which may be selected includes a total of five, including three resolution inputs 1032, 1033, and 1034 from the backbone and tensors 1035 and 1036 that are output from the Nos. 1 and 2 nodes (FIG. 10D).

An essential input feature map of a No. 5 node is an input having the same resolution from the No. 2 node (1041). Furthermore, the remaining candidate input feature map which may be selected includes a total of six, including inputs 1042, 1043, and 1044 having three types of resolution from the backbone and tensors 1045, 1046, and 1047 that are output from the Nos. 1, 3, and 4 nodes, respectively (FIG. 10E).

The essential input feature map of a No. 6 node is an input having the same resolution from the No. 1 node (1051). Furthermore, the remaining candidate input feature map which may be selected includes a total of seven, including inputs 1052, 1053, and 1054 having three types of resolution from the backbone and tensors 1055, 1056, 1057, and 1058 that are output from the Nos. 2 to 5 nodes, respectively (FIG. 10F).

FIG. 11 is a diagram for describing a process of adjusting spatial size information of an input feature map candidate group in an embodiment of the present disclosure.

As an embodiment, in the present disclosure, when spatial size information of an output feature map is determined, spatial size information of an input feature map candidate group is adjusted so that the spatial size information of the input feature map candidate group corresponds to the output feature map (S220). In this case, the spatial size information of the input feature map candidate group is adjusted through a resolution adjustment process 1110 and a channel scaling process 1120.

In the resolution adjustment process 1110, a feature operation 1111 is performed on an input feature map. In the feature operation 1111, an operation block that is used in a backbone is basically applied. For example, the operation block may be the repetition of a simple “convolution product+arrangement normalization+activation function”, may be a bottleneck structure that is introduced from MobileNet V.2, and may be a cross stage partial network (CSP) form.

Furthermore, down- (or up-) sampling 1112 and 1113 is performed in stages based on a feature map pyramid layer. That is, the down- (or up-) sampling 1112 and 1113 may be performed at once. If there is a difference between two or more layers of resolution depending on a neck structure for a systematic approach, a structure in which the sampling 1112 and 1113 is performed in stages has been adopted. Furthermore, a block 1121 for a channel increase (or decrease) has been added to the down- (or up-) sampling 1112 and 1113 after the sampling so that the length of a channel is not changed.

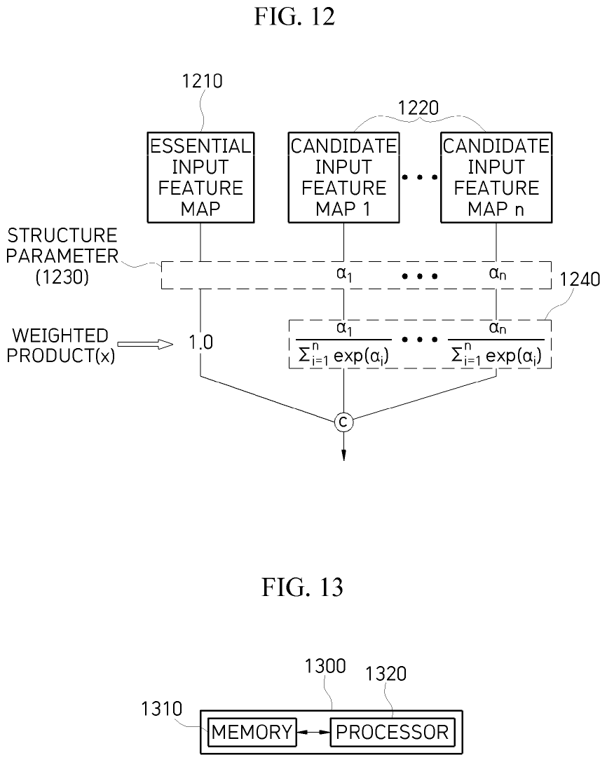

FIG. 12 is a diagram for describing contents in which a structure parameter is applied to an input feature map candidate group in an embodiment of the present disclosure.

In an embodiment of the present disclosure, when spatial size information of an input feature map candidate group is adjusted, a channel-based concatenation operation is performed on the input feature map candidate group (S230).

Referring to FIG. 12, assuming that a total number of candidate input feature maps except an essential input feature map 1210 is N (1220), after spatial size information of the candidate input feature maps is adjusted, the inputs of the candidate input feature maps are concatenated in the direction of a channel. In this case, the inputs of the candidate input feature maps each are multiplied by a value of a structure parameter 1230 and then concatenated. In this case, the structure parameter 1230 is a parameter that is trained while learning is performed.

Furthermore, the structure parameter 1230 has a real number value to which a softmax function 1240 has been applied. The softmax function 1240 is a differentiable value which allows the structure parameter 1230 to have a value between 0 and 1 while having a kind of probability value property so that the sum of all of the values becomes 1.

When the channel-based concatenation operation in step S230 is completed, the channel scaling operation S240 and the input feature map candidate group addition process S250 are performed. Learning for one-shot neural network search (one-shot NAS) is performed on a super-net including each node corresponding to an additionally extended input feature map candidate group (S260).

Specifically, in the present disclosure, a one-shot neural network can be searched for even through stochastic gradient descent (SGD) because the differentiable structure parameter has been included in a learning path. That is, such a method is a method of training and comparing all of several candidate groups, but does not require an evolution algorithm or separate reinforcement learning for sampling which combination, among the several candidate groups, is selected. In an embodiment of the present disclosure, a one-shot neural network can be searched for by performing training on one super-net.

According to the present disclosure, in the learning process, learning is performed in a way to reduce a loss function for a super-net, and a value of a structure parameter is also updated. Accordingly, the contributiveness of a channel by a specific input candidate will be increased and the contributiveness of the channel by another input candidate will be decreased, with respect to the output tensor of a concatenation node in FIG. 12. The training for the super-net is completed through a preset learning number or a loss value.

A method of deriving an optimal neck structure with respect to the super-net on which training has been completed may include the following several methods. A common object of the several methods is to prune an unnecessary input to a node. That is, in an embodiment of the present disclosure, an input to a node can be removed from the node having a structure parameter that satisfies a predetermined condition in a super-net on which training has been completed.

In this case, the predetermined condition may include setting a reference value and removing an input having a value of a structure parameter, which is equal to or smaller than the reference value. Another condition may include aligning inputs to all nodes in order of the values of structure parameters and removing an input having a lower rank (e.g., lower 10% or less). Still another condition may include aligning inputs to nodes in order of the values of structure parameters with respect to each node and then removing connection lines with the remaining inputs with only a preset number of inputs (e.g., two inputs including an essential input) left behind.

When an optimal neck structure is derived, re-training may be performed on a structure on which pruning has been completed. The final accuracy results may be derived through verification data.

In the aforementioned description, steps S210 to S260 may be further divided into additional steps or may be combined into smaller steps depending on an implementation example of the present disclosure. Furthermore, some of the steps may be omitted, if necessary, and the sequence of the steps may be changed. Furthermore, although contents are omitted, the contents of FIGS. 1 to 12 may also be applied to the method of generating signal images in FIG. 13.

Hereinafter, a server 1300 for searching for optimal neural network architecture based on channel concatenation according to an embodiment of the present disclosure is described with reference to FIG. 13.

The server 1300 according to an embodiment of the present disclosure includes memory 1310 and a processor 1320.

The memory 1310 stores a program for searching for optimal neural network architecture based on channel concatenation.

When executing the program stored in the memory 1310, the processor 1320 adjusts spatial size information of an input feature map candidate group so that the spatial size information of the input feature map candidate group corresponds to an output feature map, and performs a channel-based concatenation operation on the input feature map candidate groups. Furthermore, the processor 1320 additionally extends an output feature map, that is, the results of the channel-concatenated operation, to an input feature map candidate group, and performs learning for searching for a one-shot neural network on a super-net including each node corresponding to the additionally extended input feature map candidate group.

The aforementioned embodiment of the present disclosure may be implemented in the form of a program (or application) in order to be executed in combination with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of searching for optimal neural network architecture based on channel concatenation, the method being performed by a computer and comprising:
adjusting spatial size information of an input feature map candidate group so that the spatial size information of the input feature map candidate group corresponds to spatial size information of an output feature map;
performing a channel-based concatenation operation on the input feature map candidate group; and
additionally extending an output feature map that is results of the channel-concatenated operation to the input feature map candidate group.

2. The method of claim 1, further comprising:
setting the spatial size information of the output feature map; and
determining an input feature map to be included in the input feature map candidate group based on the spatial size information of the output feature map.

3. The method of claim 2, wherein the setting of the spatial size information of the output feature map comprises setting the spatial size information of the output feature map so that the spatial size information of the output feature map to corresponds spatial size information of an output feature map in a corresponding node according to a path aggregation network (PAN) path sequence.

4. The method of claim 3, wherein the determining of the input feature map to be included in the input feature map candidate group based on the spatial size information of the output feature map comprises:
when a first node according to the PAN path sequence is a node connected to a backbone,
setting an input feature map having identical resolution from the backbone as an essential input feature map; and
setting an input feature map having different resolution from the backbone as a candidate input feature map, wherein when an output feature map from another node is present, an output feature map from the another node is set as the candidate input feature map.

5. The method of claim 3, wherein the determining of the input feature map to be included in the input feature map candidate group based on the spatial size information of the output feature map comprises:
when a second node according to the PAN path sequence is a node connected to a first node not a backbone,
setting an input feature map having identical resolution from the first node as an essential input feature map; and
setting an input feature map from the backbone as a candidate input feature map, wherein when an output feature map from another node except the first node is present, an output feature map from the another node is set as the candidate input feature map.

6. The method of claim 1, wherein the adjusting of the spatial size information of the input feature map candidate group so that the spatial size information of the input feature map candidate group corresponds to spatial size information of an output feature map comprises adjusting the spatial size information of the input feature map to be identical with the spatial size information of the output feature map by applying a convolution product operation having a stride size of 2 or more and a 1×1 convolution product operation when spatial size information of an input feature map included in the input feature map candidate group is greater than the spatial size information of the output feature map.

7. The method of claim 1, wherein the adjusting of the spatial size information of the input feature map candidate group so that the spatial size information of the input feature map candidate group corresponds to spatial size information of an output feature map comprises adjusting the spatial size information of the input feature map to be identical with the spatial size information of the output feature map by applying an up-sampling operation and a 1×1 convolution product operation when spatial size information of an input feature map included in the input feature map candidate group is smaller than the spatial size information of the output feature map.

8. The method of claim 1, wherein the performing of the channel-based concatenation operation on the input feature map candidate group comprises applying a structure parameter and a softmax function to each of candidate input feature maps except an essential input feature map, in the input feature map candidate group.

9. The method of claim 8, further comprising performing learning for searching for a one-shot neural network on a super-net comprising each node corresponding to the additionally extended input feature map candidate group.

10. The method of claim 9, wherein the performing of the learning for searching for the one-shot neural network on the super-net comprises removing an input from a node having a structure parameter that satisfies a predetermined condition in the super-net on which the learning has been completed.

11. The method of claim 1, further comprising performing channel scaling operation on the output feature map that is the results of the channel-concatenated operation.

12. A method of searching for optimal neural network architecture based on channel concatenation, the method comprising:
setting spatial size information of an output feature map;
adjusting spatial size information of an input feature map candidate group so that the spatial size information of the input feature map candidate group corresponds to spatial size information of an output feature map;
performing a channel-based concatenation operation on the input feature map candidate group;
additionally extending an output feature map that is results of the channel-concatenated operation to the input feature map candidate group; and
performing learning for searching for a one-shot neural network on a super-net comprising each node corresponding to the additionally extended input feature map candidate group.

13. A server for searching for optimal neural network architecture based on channel concatenation, the server comprising:
memory in which a program for searching for optimal neural network architecture based on channel concatenation is stored; and
a processor configured to set spatial size information of an output feature map, adjust spatial size information of an input feature map candidate group so that the spatial size information of the input feature map candidate group corresponds to spatial size information of an output feature map, perform a channel-based concatenation operation on the input feature map candidate group, additionally extend an output feature map that is results of the channel-concatenated operation to the input feature map candidate group, and perform learning for searching for a one-shot neural network on a super-net comprising each node corresponding to the additionally extended input feature map candidate group, when executing the program stored in the memory.

14. The server of claim 13, wherein the processor
sets the spatial size information of the output feature map so that the spatial size information of the output feature map corresponds to spatial size information of an output feature map in a corresponding node according to a path aggregation network (PAN) path sequence, and
determines an input feature map to be included in the input feature map candidate group based on the spatial size information of the output feature map.

15. The server of claim 13, wherein when a first node according to the PAN path sequence is a node connected to a backbone, the processor
sets an input feature map having identical resolution from the backbone as an essential input feature map, and
sets an input feature map having different resolution from the backbone as a candidate input feature map, wherein when an output feature map from another node is present, the processor sets an output feature map from the another node as the candidate input feature map.

16. The server of claim 13, wherein when a second node according to the PAN path sequence is a node connected to a first node not a backbone, the processor
sets an input feature map having identical resolution from the first node as an essential input feature map, and
sets an input feature map from the backbone as a candidate input feature map, wherein when an output feature map from another node except the first node is present, the processor sets an output feature map from the another node as the candidate input feature map.

17. The server of claim 13, wherein the processor adjusts the spatial size information of the input feature map to be identical with the spatial size information of the output feature map, by applying a convolution product operation having a stride size of 2 or more and a 1×1 convolution product operation when spatial size information of an input feature map included in the input feature map candidate group is greater than the spatial size information of the output feature map and applying an up-sampling operation and a 1×1 convolution product operation when the spatial size information of the input feature map included in the input feature map candidate group is smaller than the spatial size information of the output feature map.

18. The server of claim 13, wherein the processor applies a structure parameter and a softmax function to each of candidate input feature maps except an essential input feature map in the input feature map candidate group.

19. The server of claim 13, wherein the processor removes an input from a node having a structure parameter that satisfies a predetermined condition in a super-net on which the learning has been completed.
